(19) United States
(12) Patent Application Publication
(10) Pub. No.: US 2021/0224466 A1
(43) Pub. Date: Jul. 22, 2021

(54) METHODS AND SYSTEMS FOR GEOGRAPHIC MAP GENERATION AND RENDERING AND UNIQUE MILES AND ROUTES NAVIGATION

(71) Applicant: TerraQuest, LLC, Crested Butte, CO (US)

(72) Inventors: Derrick Nehrenberg, Crested Butte, CO (US); Aaron Blondeau, Salida, CO (US)

(21) Appl. No.: 17/153,352

(22) Filed: Jan. 20, 2021

Related U.S. Application Data
(60) Provisional application No. 62/963,588, filed on Jan. 21, 2020.

(51) Int. Cl. G06F 40/14; G06F 40/106; G06F 16/29; G06F 16/22; G09B 29/00

(52) U.S. Cl. CPC G06F 40/14; G06F 40/106; G09B 29/003; G06F 16/2282; G06F 16/29

(57) ABSTRACT

Embodiments of the disclosure provide systems and methods for generating and rendering index tile-based vector maps of geographic areas. According to one embodiment, generating an index tile-based vector map of a geographic area can comprise maintaining a plurality of map geometries representing the geographic area. Each geometry of the plurality of geometries can have a geometry type and can characterize a geographic feature represented in the geographic area. An index tile can be generated by the server for each map tile or bounding box for a map render area. The index tile can comprise a list of each geometry type in the map tile and a list of identifiers for each geometry type. The generated index tiles for the plurality of map geometries can be provided to a mobile device and used to download geometries of the map tiles.

### CROSS REFERENCE TO RELATED APPLICATION

The present application claims the benefits of and priority, under 35 U.S.C. § 119(e), to U.S. Provisional Application No. 62/963,588 filed Jan. 21, 2020 by Nehrenberg, et. al. and entitled “Methods and Systems for Unique Miles and Routes Navigation” of which the entire disclosure is incorporated herein by reference for all purposes.

### FIELD OF THE DISCLOSURE

Embodiments of the present disclosure relate generally to methods and systems for geographic map generation and rendering and more particularly to generating and rendering index tile-based vector maps of geographic areas.

### BACKGROUND

Current geographic map rendering tools work by taking map data and dividing it into small squares called tiles. The data for each tile is then sent from the server to the device using a vector format, such as MapBox's PBF, for example. The device then uses the vector data to render an image for the tile. This drastically reduces the amount of data downloaded as compared to technologies where each map tile is rendered as a raster image, such as a PNG file, on the server and sent to the device. Map tiles commonly use Slippy tilenames where each tile consists of an X and Y coordinate as well as a zoom level (Z). Unfortunately, vector map rendering technologies continue to work in a way similar to old raster technologies where the data for each tile is delivered as a single x,y,z vector file. This means that as users zoom in and out on the map, new vector tiles must be downloaded for each zoom level. Maps that are meant to work offline must download the data for each and every zoom level, consuming a massive amount of data. Hence, there is a need for improved methods and systems for generating and rendering geographic maps.

### BRIEF SUMMARY

Embodiments of the disclosure provide systems and methods for generating and rendering index tile-based vector maps of geographic areas. According to one embodiment, a method for generating an index tile-based vector map of a geographic area can comprise maintaining, by a server, a plurality of map geometries representing the geographic area. Each geometry of the plurality of geometries can have a geometry type of a plurality of geometry types, and each geometry of the plurality of geometries can characterize a geographic feature represented in the geographic area. An index tile can be generated by the server for each map tile or bounding box for a map render area. The index tile can comprise a list of each geometry type in the map tile and a list of identifiers for each geometry type, the list of identifiers can indicate the geometries of the plurality of geometries for each geometry type. The generated index tiles for the plurality of map geometries can be provided by the server to a mobile device and the mobile device can use one or more of the index tiles to download the plurality of geometries of one or more map tiles.

A request to download one or more geometries of at least one map tile or bounding box for a map render area can be received by the server from the mobile device. In response to the request to download the one or more geometries of the at least one map tile or bounding box, the server can provide to the mobile device the requested one or more geometries. In some cases, the request to download the one or more geometries of the at least one map tile or bounding box can comprise a request to download an individual geometry identified in one of the generated index tiles provided to the mobile device. In other cases, the request to download the one or more geometries of the at least one map tile or bounding box can comprise one of the generated index tiles provided to the mobile device and providing the requested one or more geometries can comprise providing, by the server, to the mobile device, all of the geometries identified in the index tile provided with the request.

In some cases, each index tile can comprise a JavaScript Object Notation (JSON) document. Additionally, or alternatively, the request to download the one or more geometries of the at least one map tile or bounding box can comprise a JSON document requesting only specific geometries of one or more index tiles. For example, the JSON document can comprise one or more keys, each key comprising a geometry type, and a value comprising either a Boolean value or a tag name for one or more geometries.

According to another embodiment, a method for rendering an index tile-based vector map of a geographic area can comprise receiving, by a mobile device, from a server, an index tile for each map tile of a plurality of map geometries for the geographic area. Each map tile can comprise a plurality of geometries, each geometry of the plurality of geometries can have a geometry type of a plurality of geometry types, and each geometry of the plurality of geometries can characterize a geographic feature represented in the map tile. The index tile can comprise a list of each geometry type in the map tile and a list of identifiers for each geometry type, the list of identifiers indicating the geometries of the plurality of geometries for each geometry type.

The mobile device can request, from the server, one or more geometries of at least one map tile or bounding box for a map render area based on at least one of the index tiles. In response to requesting the one or more geometries of the at least one map tile or bounding box, the mobile device can download, from the server, the requested one or more geometries. In some cases, requesting the one or more geometries of the at least one map tile or bounding box can comprise requesting to download an individual geometry identified in one of the generated index tiles provided to the mobile device. In other cases, requesting the one or more geometries of the at least one map tile or bounding box can comprise providing, by the mobile device, to the server, one of the index tiles received by the mobile device and downloading the requested one or more geometries can comprise downloading, by the mobile device, from the server, all of the geometries identified in the provided index tile. In some cases, each index tile can comprise a JavaScript Object Notation (JSON) document. Additionally, or alternatively, downloading the one or more geometries of the at least one map tile or bounding box can comprise providing, by the mobile device, to the server, a JSON document requesting only specific geometries of one or more index tiles. In such cases, the JSON document can comprise one or more keys, each key comprising a geometry type, and a value comprising either a Boolean value or a tag name for one or more geometries.

The mobile device can, in some cases, cache the downloaded one or more geometries. The downloaded and/or cached one or more geometries can be trimmed by the mobile device to fit within boundaries for the at least one map tile or bounding box and the trimmed one or more geometries can be converted to screen x, y coordinates. The at least one map tile or bounding box can then be rendered by the mobile device using the screen x, y coordinates.

According to yet another embodiment, a system can comprise a server comprising a processor and a memory coupled with and readable by the processor and storing therein a set of instructions which, when executed by the processor of the web server, can cause the processor of the web server to generate an index tile-based vector map of a geographic area by maintaining a plurality of map geometries representing the geographic area. Each geometry of the plurality of geometries can have a geometry type of a plurality of geometry types and each geometry of the plurality of geometries can characterize a geographic feature represented in the geographic area. The instructions stored in the memory of the server can further cause the server to generate an index tile for each map tile or bounding box for a map render area. The index tile can comprise a list of each geometry type in the map tile and a list of identifiers for each geometry type. The list of identifiers can indicate the geometries of the plurality of geometries for each geometry type. The instructions stored in the memory of the server can further cause the server to provide the generated index tiles for the plurality of map geometries and the mobile device can use one or more of the index tiles to download the plurality of geometries of one or more map tiles.

A mobile device can be communicatively coupled with the server. The mobile device can comprise a display device, a processor coupled with the display device, and a memory coupled with and readable by the processor of the mobile device. The memory of the mobile device can store therein a set of instructions which, when executed by the processor of the mobile device, can cause the processor of the mobile device to render the index tile-based vector map by receiving, from the server, the provided index tiles for the plurality of map, and requesting, from the server, one or more geometries of at least one map tile or bounding box for a map render area based on at least one of the index tiles. In some cases, requesting the one or more geometries of the at least one map tile or bounding box can comprise requesting to download an individual geometry identified in one of the generated index tiles provided to the mobile device. In other cases, requesting the one or more geometries of the at least one map tile or bounding box can comprises providing, by the mobile device, to the server, one of the index tiles received by the mobile device and downloading the requested one or more geometries can comprise downloading, by the mobile device, from the server, all of the geometries identified in the provided index tile. In some cases, each index tile can comprise a JavaScript Object Notation (JSON) document. Additionally, or alternatively, downloading the one or more geometries of the at least one map tile or bounding box can comprise providing, by the mobile device, to the server, a JSON document requesting only specific geometries of one or more index tiles. The JSON document can comprise one or more keys, each key comprising a geometry type, and a value comprising either a Boolean value or a tag name for one or more geometries.

The instructions stored in the memory of the server can further cause the processor of the server to receive, from the mobile device, the request for the one or more geometries of at least one map tile or bounding box and in response to the request, provide, to the mobile device, the requested one or more geometries. The instructions stored in the memory of the mobile device can further cause the processor of the mobile device to download, from the server, the requested one or more geometries. In some cases, the instructions stored in the memory of the mobile device can further cause the processor of the mobile device to cache the downloaded one or more geometries. The instructions stored in the memory of the mobile device can further cause the processor of the mobile device to trim the downloaded and/or cached one or more geometries to fit within boundaries for the at least one map tile or bounding box, convert the trimmed one or more geometries to screen x, y coordinates, and render, on the display device, the at least one map tile or bounding box using the screen x, y coordinates.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating elements of an environment in which embodiments of the present disclosure may be implemented.

FIG. 4 is a flowchart illustrating an exemplary process for accumulating uniquely traveled miles according to one embodiment of the present disclosure.

FIG. 5 is a screenshot illustrating an exemplary user interface presenting a leaderboard according to one embodiment of the present disclosure.

FIG. 6 is a screenshot illustrating an exemplary user interface presenting contest regions according to one embodiment of the present disclosure.

FIG. 7 is a screenshot illustrating an exemplary user interface presenting a contest region scorecard according to one embodiment of the present disclosure.

FIG. 8 is a screenshot illustrating an exemplary user interface presenting a track mileage explanation according to one embodiment of the present disclosure.

FIG. 9 is a screenshot illustrating an exemplary route builder user interface for adding geometries to a route according to one embodiment of the present disclosure.

FIG. 10 is a screenshot illustrating an exemplary route builder user interface for adding geometry options to a route according to one embodiment of the present disclosure.

FIG. 11 is a screenshot illustrating an exemplary route builder user interface for adding route instructions to a route according to one embodiment of the present disclosure.

FIG. 12 is a screenshot illustrating an exemplary route builder user interface for adding a route astray to a route according to one embodiment of the present disclosure.

FIG. 13 is a screenshot illustrating an exemplary user interface including a map legend according to one embodiment of the present disclosure.

FIG. 14 is a screenshot illustrating an exemplary user interface including a piste map legend according to one embodiment of the present disclosure.

FIG. 15 is a screen shot of a rendered map according to one embodiment of the present disclosure.

FIG. 16 is a flowchart illustrating an exemplary process for vector map rendering according to one embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

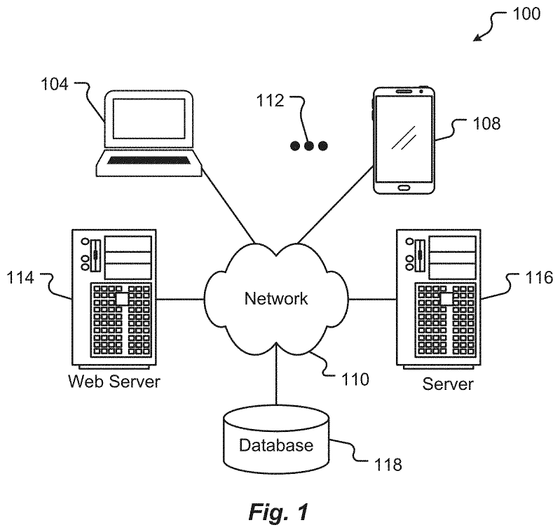

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

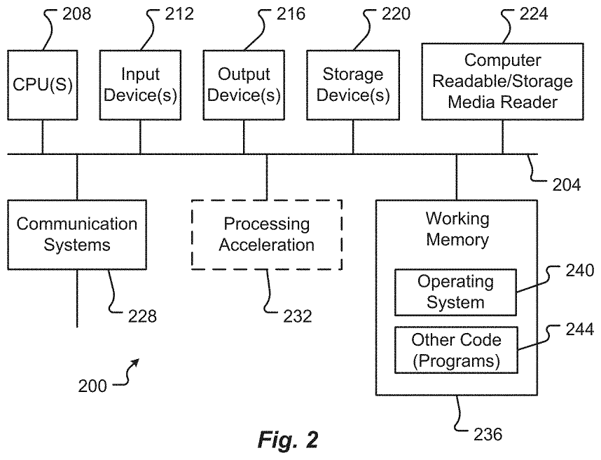

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

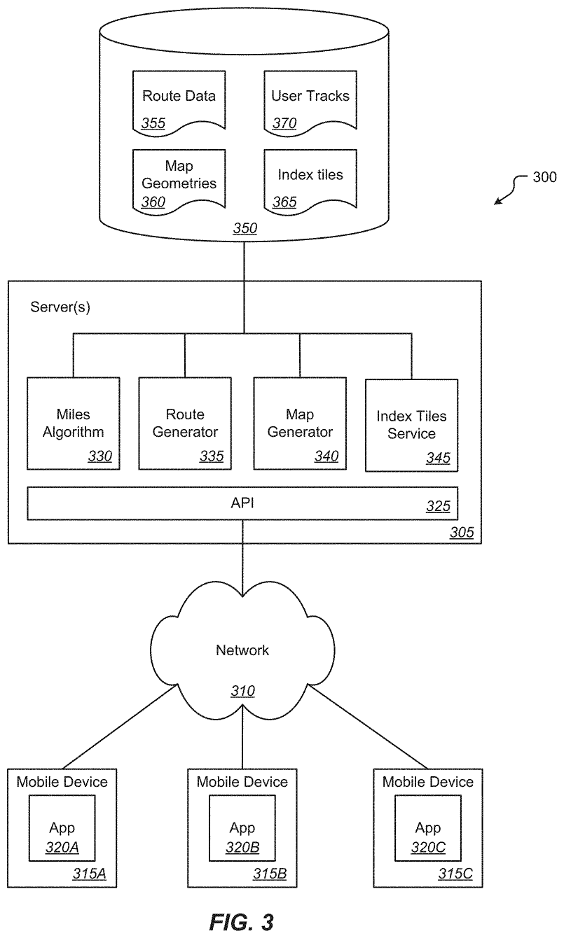

FIG. 3 is a block diagram illustrating elements of an environment in which embodiments of the present disclosure may be implemented. As illustrated in this example, the environment 300 can include a set of one or more navigation services 330, 335, 340, and 345 implemented on one or more web servers 305 or other systems as described above. The server(s) 305 and the one or more navigation services 330, 335, 340, and 345 can be communicatively coupled with one or more communications networks 310 such as any one or more of the wired or wireless networks described above. Also communicatively coupled with the network(s) 310 can be any number of mobile devices 315A-315C and/or other computing devices (not shown here) such as any of the devices described above. The mobile devices 315A-315C can include, but are not limited to cellphone, tablets, smart watches, etc. Each mobile device 315A-315C can execute an application 320A-320C for communicating with and utilizing the one or more navigation services 330, 335, 340, and 345.

The one or more navigation services 330, 335, 340, and 345 can utilize an Application Program Interface (API) 325 through which the applications 320A-320C executing on the mobile devices 315A-315C can access and utilize functions and features of the one or more navigation services 330, 335, 340, and 345 provided by one or more applications executing on the server(s) 305. Generally speaking, one or more navigation services 330, 335, 340, and 345 can receive location information from each of the mobile devices 315A-315C and track that location as a user of the mobile device 315A-315C travels along a route, e.g., while hiking, mountain biking, skiing, etc. The route can be predefined and saved in a set of route data 355 The user tracks data 370 can be saved in a database 350 such as described above or other repository. According to one embodiment, the route data 355 and user tracks data 370 can be stored in a PostgreSQL database using the PostGIS extension. Using the user tracks data 370, the one or more navigation services 330, 335, 340, and 345 can compare users in a formal or informal contest or competition, e.g., to determine which participate has traveled the most miles etc. The one or more navigation services 330, 335, 340, and 345 can also provide details of the routes traveled, provide details of new route that might be traveled, provide maps showing the routes traveled and/or routes available, etc. These details and maps can be rendered by the applications 320A-320C executing the mobile devices 315A-315C for viewing by the users.

More specifically, a miles algorithm 330 or application can be executed by the server(s) 305. This miles algorithm 330 can, based on location information received from each mobile device 315A-315C through the API 325, track and cumulate unique route miles traveled by the user of the mobile device #15A-315C. As used herein, the term unique route miles refers to miles of routes or portions of routes traveled by a user the first time the user completes the route and only the first time. Based on this information, the one or more navigation services 330, 335, 340, and 345 and application 320A-320C executing on the mobile devices 315A-315C can provide a user interface that shows a color-coded or other graphical representation of mileage detail of how unique miles of routes are calculated that can include, but is not limited to, the recorded track, the track's path that counts as the route, routes visited before the track, routes not visited before the track, and/or new unique route miles added by the track. As noted above, the one or more navigation services 330, 335, 340, and 345 can use the unique route miles information as the basis of a routes-based, unique miles contest were users compete to accumulate the most unique miles on a leaderboard. Such a leaderboard that can be filtered by individual routes and by route statistics (e.g. distance, time, speed, etc.), for example.

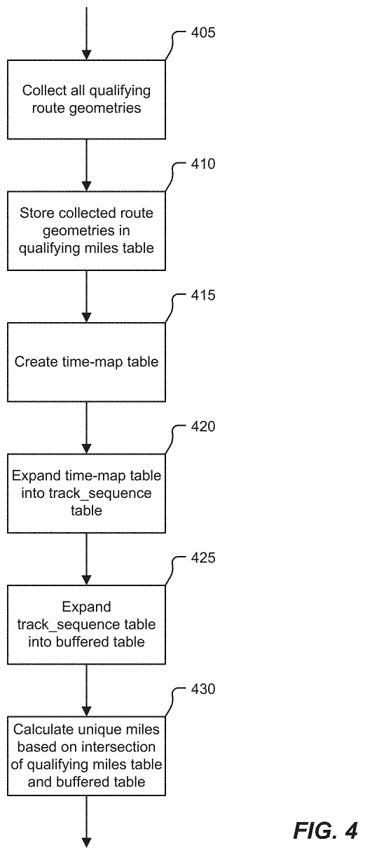

Generally speaking, determining unique route miles traveled by an individual can comprise collecting a set of geometries, i.e., a characterization or definition of a geographic feature represented in the map geometries 360. Collecting these geometries can comprise collecting the geometries for all routes and/or route segments that are “qualified,” i.e., that are part of a contest or other formal or informal collection of routes and/or route segments that can be presented to users of the navigation services 330, 335, 340, and 345. These geometries can be stored in a table of “qualified miles.” Another sequence of tables can be built representing the routes traveled by a user at various times. The resulting table of this sequence of tables which can represent an index of all tracks recorded for the user within the geographic region can then be used to determine unique route miles for that user based on an intersection of the tracks recorded for the user within the geographic region and the qualified miles in that region. Additional details of an exemplary process, such as may be executed by the miles algorithm 330 or application, for determining unique route miles will be described further below with reference to FIG. 4.

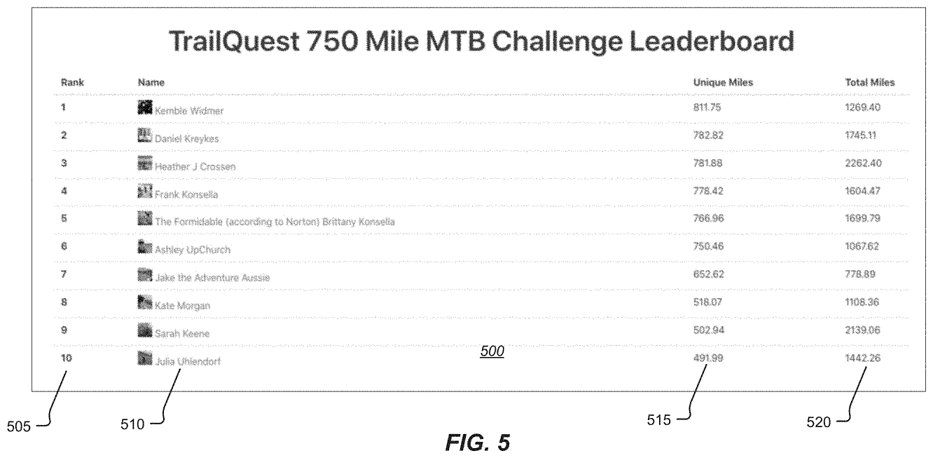

According to one embodiment, the server(s) 305 can also execute a turn-by-turn route generator and/or navigator application 335. This application can provide to the mobile devices 315A-315C for rendering by the applications 320A-320C executing thereon, a user interface for generated routes and customizable directions e.g., turns, astrays, and confirmations, that can be followed on the mobile devices 315A-315C as the users travel along the routes. In some cases, routes can be generated and synced to OpenStreetMap (OSM) data, other forms of Geographic Information System (GIS) data, or independently from GIS data. In some cases, the route generator 335 can be used to create routes of or including unique route miles. A number of exemplary user interfaces as may be rendered on the mobile devices including interfaces for the miles algorithm 330 or application as described above as well as interfaces for the route generator 335 will be described further below with reference to FIGS. 5-12.

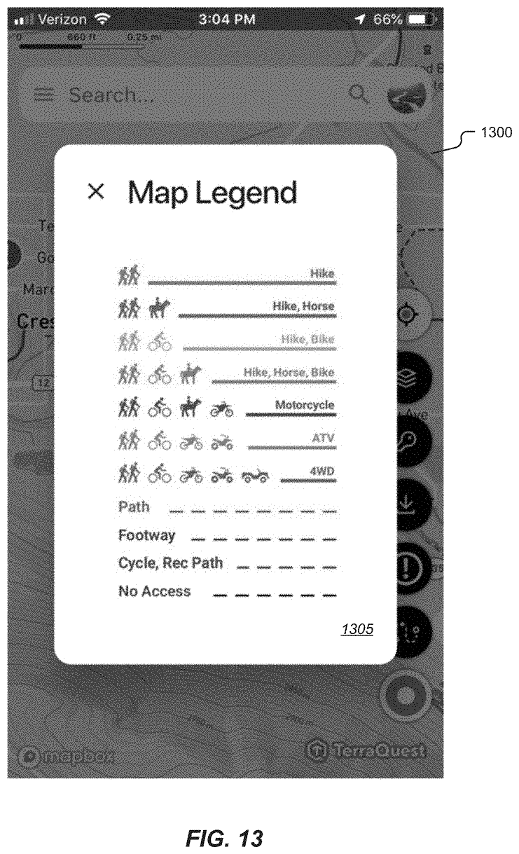

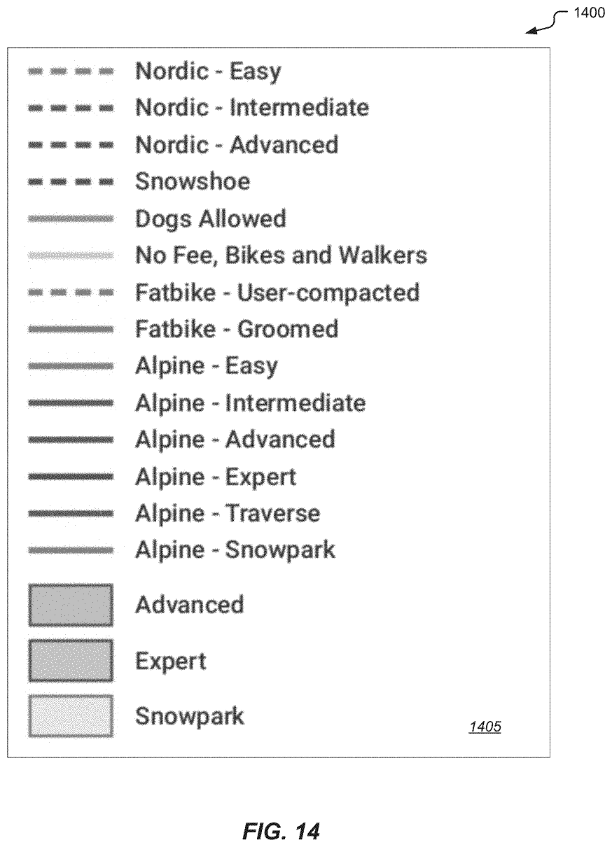

According to one embodiment, the server(s) 305 can also execute a map generator 340. The map generator 340 can provide to the mobile devices 315A-315C for rendering by the applications 320A-320C executing thereon a multiuser trail map consisting of a base map generated from a custom OSM) tag data filter combined with routes provided by the route generator 335. More specifically, a custom filter can be used by the map generator 340 to pull in OSM tags that can be used to style trails according to the permitted uses of the trail. The trails can be displayed in a custom base map layer. The routes from the route generator 335 can be displayed on top of the base map layer. In some cases, a routes link can also be presented that links to the unique miles leaderboard described above. Additional details of some exemplary user interfaces including such map styles will be described further below with reference to FIGS. 13 and 14.

According to one embodiment, the server(s) 305 can also execute one or more application providing an index tile service 345. In some cases, the maps generated by the map generator 340 and rendered by the applications 320A-320C executing on the mobile devices 315A-315C can be generated by the index tile service 345 as index tile-based vector maps. Generally speaking, generating and rendering index tile-based vector maps can begin with the index tiles service or application 345 maintaining and providing an “index tile” 365 for every x, y, z map geometry 360 in one or more geographic regions. The index tile 365 can comprise a list of IDs for each type of geometry that would be rendered in that tile. Each request for an index tile 365 can contain a filter parameter as will be described below. According to one embodiment, each index tile 365 can be a JavaScript Object Notation (JSON) document. An exemplary format for such a document can be:

{

type1: [id1, id2, id3, ...],
type2: [id4, id5, id6, ...],
x: #,
y: #,
z: #,

}

Additionally, or alternatively, index tiles can be a Concise Binary Object Representation (CBOR) document. CBOR compresses data into a smaller format and reduces download size. However, it requires more computation to decode on the client device. In some implementations, the client device can decide between the two formats, for example, by appending .json or .cbor to the request.

Index tile 365 can use points, roads, lines, and polygons. These can correspond to the osm2pgsql database format. However, any type of postgis spatial table can be used such as an imported shapefile. An example index tile 365 can be:

| /** | |
|---|---|
| * | @swagger |
| * | definitions: |
| * | iTile: |

| | |
|---|---|
| * | type: “object” |
| * | properties: |
| * | x: |

| | |
|---|---|
| * | type: integer |

| | |
|---|---|
| * | y: |

| | |
|---|---|
| * | type: integer |

| | |
|---|---|
| * | z: |

| | |
|---|---|
| * | type: integer |

| | |
|---|---|
| * | points: |

| | |
|---|---|
| * | type: array |
| * | items: |
| * | type: object |

| | |
|---|---|
| * | roads: |

| | |
|---|---|
| * | type: array |
| * | items: |
| * | type: object |

| | |
|---|---|
| * | lines: |

| | |
|---|---|
| * | type: array |
| * | items: |
| * | type: object |

| | |
|---|---|
| * | polygons: |

| | |
|---|---|
| * | type: array |
| * | items: |
| * | type: object |

*/

Given the index tile's list of geometries, the map rendering client application, i.e., the application 320A executing on the mobile device 315A of a user, can then download each geometry and render it. Geometries can be requested by the client application 320A individually or in groups called packs by sending an index tile 365 (see format above) to the index tiles service or application 345. According to ne embodiment, the client application 320A can cache each geometry that it downloads on the mobile device 315A, so that each map feature only needs to be downloaded once for all zoom levels. Once the client application 320A has gained access to each geometry via cache or download, it can then trim the geometry to fit within the bounds or an un-tiled generic map bounding area, convert each geometry's latitude and longitude into screen x and y coordinates, and then render the geometry within the map geometry 360.

According to one embodiment, complete map geometries 360 can be stored. When an index tile request is received requesting geometries in a particular tile, the bounds of the tile can be computed. A spatial query can then be made to the database to determine which geometries intersect those bounds. In heavy usage scenarios certain index tiles can be precomputed or the responses for frequently requested index tiles cache can be cached. The server can return an index for any rectangular map area, not just slippy map tiles. This allows client devices that do not render with slippy map tiles to determine what geometries lie within the space they are rendering.

As noted above, each request for an index tile 365 can contain a filter parameter. More specifically, and according to one embodiment, the database 350 maintaining the route data 355 can comprise a spatial database where geometries are tagged, e.g., key, value—HSTORE on PostGRES databases. In such cases, a JSON document format as follows can be used by the client application 320A to request only geometries it is interested in rendering. In this format, each key in the document can be a geometry type and each value in the document can be either the boolean value false (exclude this geometry type entirely) or a sub-document where each key is a tag name, and each value can be one of the following:

a string—geometry included if tag value equals string;

an array of strings—geometry included if tag value is in the array;

a subdocument with key=exists, and value=true—geometry included if tag exists;

a subdocument with key=exists, and value=false—geometry included if tag does not exist;

a subdocument with key=equals, and value=string—geometry included if tag value equals string;

a subdocument with key=not_equals, and value=string—geometry included if tag value does not equal string;

a subdocument with key=like, and value=string—geometry included if tag value is LIKE string;

a subdocument with key=not_like, and value=string—geometry included if tag value is not LIKE string;

a subdocument with key=in, and value=an array of strings—geometry included if tag value is in the array; or

a subdocument with key=not_in, and value=an array of strings—geometry included if tag value is not in the array.

Following this format, one example filter can be:

| | |
|---|---|
| * | iTileFilter: |
| * | type: “object” |
| * | properties: |

| | |
|---|---|
| * | points: |
| * | description: Filter for points |
| * | reqired: false |
| * | $ref: ‘#/definitions/iTileElementFilter’ |
| * | roads: |
| * | description: Filter for roads |
| * | reqired: false |
| * | $ref: ‘#/definitions/iTileElementFilter’ |
| * | lines: |
| * | description: Filter for lines |
| * | reqired: false |
| * | $ref: ‘#/definitions/iTileElementFilter’ |
| * | polygons: |
| * | description: Filter for polygons |
| * | reqired: false |
| * | $ref: ‘#/definitions/iTileElementFilter’ |

Of course, these exemplary filters are provided by way of example only and are not intended to limit the scope of the present disclosure. Instead, a wide variety of filters according to this or modified formats are contemplated and considered to be within the scope of the present disclosure.

Stated another way, a web server 305 comprising a processor and a memory coupled with and readable by the processor and storing therein a set of instructions, such as the index tile service 345 or application, which, when executed by the processor of the web server 305, can cause the processor of the web server 305 to generate an index tile-based vector map of a geographic area by maintaining, in a database or other repository 350, a plurality of map geometries 360 representing the geographic area. Each geometry of the plurality of map geometries 360 can have a geometry type of a plurality of geometry types, and each geometry of the plurality of geometries can characterize a geographic feature represented in the geographic area. The instructions stored in the memory of the server 305 can further cause the server 305 to generate an index tile 365 for each map tile or bounding box for a map render area. The index tile 365 can comprise a list of each geometry type in the map or bounding box and a list of identifiers for each geometry type. The list of identifiers can indicate the geometries of the plurality of geometries for each geometry type. The instructions stored in the memory of the server 305 can further cause the server to provide the generated index tiles 365 for the plurality of map geometries 360 and the mobile device can use one or more of the index tiles 365 to download the plurality of geometries of one or more map geometries 360.

A mobile device 315A can be communicatively coupled with the server 305. The mobile device 315A can comprise a display device, a processor coupled with the display device, and a memory coupled with and readable by the processor of the mobile device 315A. The memory of the mobile device 315A can store therein a set of instructions, such as application 320A, which, when executed by the processor of the mobile device 315A, can cause the processor of the mobile device 315A to render the index tile-based vector map by receiving, from the server 305, the provided index tiles 365 for the plurality of map, and requesting, from the server 305, one or more geometries of at least one of the map geometries 360 based on at least one of the index tiles 365. In some cases, requesting the one or more geometries of the at least one map tile or bounding box can comprise requesting to download an individual geometry identified in one of the generated index tiles 365 provided to the mobile device. In other cases, requesting the one or more geometries of the at least one map tile or bounding box can comprises providing, by the mobile device 315A, to the server 305, one of the index tiles 365 received by the mobile device 315A and downloading the requested one or more geometries can comprise downloading, by the mobile device 315A, from the server 305, all of the geometries identified in the provided index tile 365. In some cases, each index tile 365 can comprise a JavaScript Object Notation (JSON) document. Additionally, or alternatively, downloading the one or more geometries of the at least one map tile or bounding box can comprise providing, by the mobile device 315A, to the server 305, a JSON document requesting only specific geometries of one or more index tiles 365. The JSON document can comprise one or more keys, each key comprising a geometry type, and a value comprising either a Boolean value or a tag name for one or more geometries.

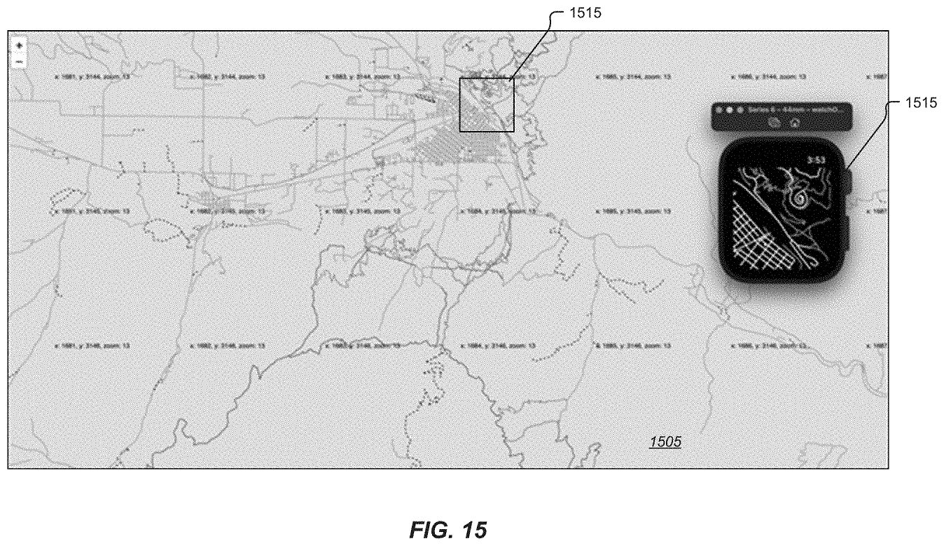

The instructions stored in the memory of the server 305 can further cause the processor of the server 305 to receive, from the mobile device 315A, the request for the one or more geometries of at least one of the map geometries 360 and in response to the request, provide, to the mobile device 315A, the requested one or more geometries. The instructions stored in the memory of the mobile device 315A can further cause the processor of the mobile device 315A to download, from the server, the requested one or more geometries. In some cases, the instructions stored in the memory of the mobile device 315A can further cause the processor of the mobile device 315A to cache the downloaded one or more geometries. The instructions stored in the memory of the mobile device 315A can further cause the processor of the mobile device 31A to trim the downloaded and/or cached one or more geometries to fit within boundaries for the at least one of the map geometries 360, convert the trimmed one or more geometries to screen x, y coordinates, and render, on the display device, the at least one of the map geometries 360 using the screen x, y coordinates. Additional details of an exemplary process for generating and rendering such index tile-based vectors maps will be described further below with reference to FIG. 15.

As noted above, the miles algorithm 330 can, based on location information received from each mobile device 315A-315C through the API 325, track and cumulate unique route miles traveled by the user of the mobile device 315A-315C. Generally speaking, determining unique route miles traveled by an individual can comprise collecting a set of geometries, i.e., a characterization or definition of a geographic feature represented in the map or bounding box. Collecting these geometries can comprise collecting the geometries for all routes and/or route segments that are “qualified,” i.e., that are part of a contest or other formal or informal collection of routes and/or route segments that can be presented to users of the navigation services 330, 335, 340, and 345. These geometries can be stored in a table of “qualified miles.” Another sequence of tables can be built representing the routes traveled by a user at various times. The resulting table of this sequence of tables which can represent an index of all tracks recorded for the user within the geographic region can then be used to determine unique route miles for that user based on an intersection of the tracks recorded for the user within the geographic region and the qualified miles in that region.

FIG. 4 is a flowchart illustrating an exemplary process for accumulating uniquely traveled miles according to one embodiment of the present disclosure. According to one embodiment and as illustrated in this example, accumulating uniquely traveled miles for a user can begin with collecting 405 from the route data all the geometries that count towards a contest or other formal or informal organization of routes and/or route segments within a specified geographic area and storing 410 them in a first table, i.e., a “qualified table.”

Based on the contents of this first table, a second table, i.e., a “time_map table,” can be created 415. This table can comprise a windowed query that contains each track found within the contest area along with the track's id (called anchor_track_id in the example below), the first start time, and the end time for each track. This table can be used as an index that allows the miles algorithm 330 to iterate through a user's tracks in order while making it fast to look up every track that occurred before the current row. An example of such a table can be:

Time_map table

| | Anchor_track_id | start_time time stamp | end_time time stamp |
|---|---|---|---|
| [symbol] | integer | with time zone | with time zone |
| 1 | 110 | 2018-04-24 23:46:09+00 | 2018-04-24 23:46:09+00 |
| 2 | 1703 | 2018-04-24 23:46:09+00 | 2018-04-26 00:03:27+00 |
| 3 | 2133 | 2018-04-24 23:46:09+00 | 2018-05-02 21:12:08+00 |
| 4 | 13728 | 2018-04-24 23:46:09+00 | 2018-10-18 20:46:52+00 |
| 5 | 14199 | 2018-04-24 23:46:09+00 | 2018-10-28 22:19:39+00 |
| 6 | 18495 | 2018-04-24 23:46:09+00 | 2019-05-12 21:32:33+00 |
| 7 | 18563 | 2018-04-24 23:46:09+00 | 2019-05-16 20:50:30+00 |
| 8 | 18892 | 2018-04-24 23:46:09+00 | 2019-05-29 23:17:32+00 |
| 9 | 19268 | 2018-04-24 23:46:09+00 | 2019-06-06 23:43:15+00 |
| 10 | 26557 | 2018-04-24 23:46:09+00 | 2019-10-22 22:00:03+00 |

This second table can be expanded 420 into a third table, i.e., a “track_sequence table.” This table can expand the time_map table by adding an index column that includes the ID of each track plus the tracks that occurred before it. These lists of IDs can then be used to gather the user's geometries for each step in time as each track is added. An example of such a table can be

Track sequence table

| | start_time time stamp | end_time time stamp | Anchor_track_id | |
|---|---|---|---|---|
| [symbol] | with time zone | with time zone | integer | [symbol] integer [symbol] |
| 1 | 2018-04-24 23:46:09+00 | 2018-04-24 23:46:09+00 | 110 | (110) |
| 2 | 2018-04-24 23:46:09+00 | 2018-04-26 00:03:27+00 | 1703 | (110, 170 [symbol] ) |
| 3 | 2018-04-24 23:46:09+00 | 2018-05-02 21:12:08+00 | 2133 | (110, 170 [symbol] ) |
| 4 | 2018-04-24 23:46:09+00 | 2018-10-18 20:46:52+00 | 13728 | (110, 170 [symbol] ) |
| 5 | 2018-04-24 23:46:09+00 | 2018-10-28 22:19:39+00 | 14199 | (110, 170 [symbol] , [symbol] 728, 1499 [symbol] ) |
| 6 | 2018-04-24 23:46:09+00 | 2019-05-12 21:32:33+00 | 18495 | (110, 170 [symbol] , 14199, 184 [symbol] ) |
| 7 | 2018-04-24 23:46:09+00 | 2019-05-16 20:50:30+00 | 18563 | (110, [symbol] ) |
| 8 | 2018-04-24 23:46:09+00 | 2019-05-29 23:17:32+00 | 18892 | (110, [symbol] ) |
| 9 | 2018-04-24 23:46:09+00 | 2019-06-06 23:43:15+00 | 19268 | (110, 1702, 2133, 13728, 14199, [symbol] ) |
| 10 | 2018-04-24 23:46:09+00 | 2019-10-22 22:00:03+00 | 26557 | ( [symbol] ) |

[symbol]

indicates data missing or illegible when filed

This third table can then be expanded 425 into yet a fourth table, i.e., a “track_sequence table.” This fourth table can be a buffered table comprising an ordered list of each of the user's tracks in the contest. Each row in the table can include the geometries for the current track and all previous tracks. These geometries can be simplified, e.g., using the Douglas-Peucker or similar algorithm, collected into a single multi-linestring, converted to a ‘buffer’ polygon by padding the line by a specific distance, and cut by a mask for the contest/geographic area to remove any segments that lie outside the contest/geographic area.

The unique mileage for the user can then be calculated 430 by finding the intersection of first table, i.e., the “qualified table,” and the fourth table, i.e., the buffered “track_sequence table.” The resulting geometry can then be measured to get the unique distance contributed by the track to the total unique moles for the user. An exemplary resulting table of unique miles can be:

Unique miles table:

| [symbol] | track_id integer | unique_length double precision |
|---|---|---|
| 1 | 110 | 23222.744735664 |
| 2 | 1703 | 33154.3798552026 |
| 3 | 2133 | 46676.425190718 |
| 4 | 13728 | 67707.4465698095 |
| 5 | 14199 | 94124.8898169324 |
| 6 | 18495 | 94847.8451376718 |
| 7 | 18668 | 94992.8888226273 |
| 8 | 18892 | 97182.8114338296 |
| 9 | 19268 | 101832.802443639 |
| 10 | 28557 | 106686.428636555 |

As noted above, the navigation services or applications 330, 335, 340, and 345 can generate and provide to the mobile devices 315A-315C a number of different user interfaces. Some such interfaces will be described below of illustrative purposes. However, it should be understood that these interfaces are presented and described merely by way of example and are not intended to limit the scope of the present disclosure. Rather, in various implementations, these interfaces can vary widely not only in format and appearance but also in content presented. Such variations are contemplated and considered to be within the scope of the present disclosure.

FIG. 5 is a screenshot illustrating an exemplary user interface presenting a leaderboard according to one embodiment of the present disclosure. More specifically, this example illustrates a web page or other interface 500 that can be generated by the miles algorithm 330 and which can present an ordered set of results for a content or other formal or informal organization of route miles. As illustrated herein, the leaderboard interface 500 can include a rank column 505, a name column 510, a unique miles column 515, and a total miles column 520 with the rows showing each user in the content and ordered based on the unique miles column 515. A number of variations in the format, appearance, and/or content of such an exemplary interface 500 are contemplated and are considered to be within the scope of the present disclosure.

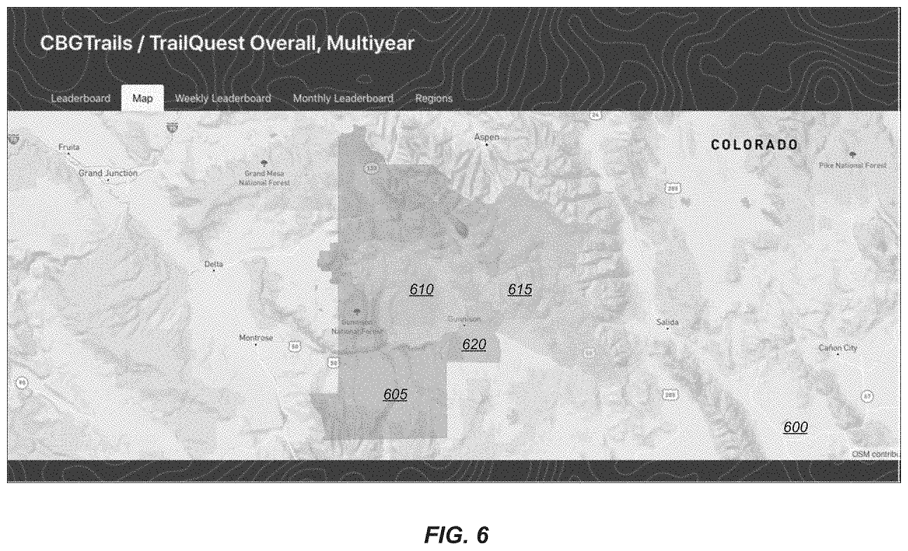

FIG. 6 is a screenshot illustrating an exemplary user interface presenting contest regions according to one embodiment of the present disclosure. More specifically, this example illustrates a web page or other interface 600 that can be generated by the miles algorithm 330 and/or map generator 340 and in which a representation of a geographic region, such as a map, may be presented. The interface may further indicate, e.g., by shading, color, dashed or solid lines, and/or other features, one or more areas 605, 610, 615, and 620 in which one or more contents, routes, etc. may be available. In some cases, that user may touch, click, or otherwise select one or these areas 605 to obtain additional information about routes within the area 605. A number of variations in the format, appearance, and/or content of such an exemplary interface 600 are contemplated and are considered to be within the scope of the present disclosure.

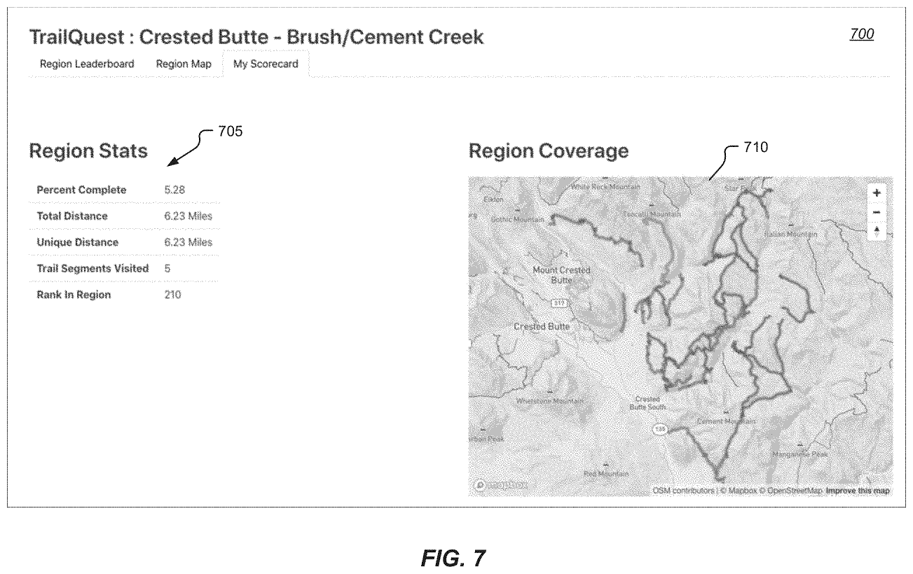

FIG. 7 is a screenshot illustrating an exemplary user interface presenting a contest region scorecard according to one embodiment of the present disclosure. More specifically, this example illustrates a web page or other interface 700 that can be generated by the miles algorithm 330 and/or map generator 340 and which may be presented, for example in response to the user touching, clicking, or otherwise selecting one of the areas 605 described above with reference to FIG. 6. As illustrated in this example, this interface 700 can include a set of statistics such as a percent of available routes the user has completed, a total distance the user has completed, total unique miles the user has completed, the number of trail segments the user has visited, the user's rank among users in the area, etc. The interface 700 can also include a map 710 illustrating routes and route segments within the area. The routes and segments may be color-coded, e.g., to show those completed and/or not completed by the user etc., and the map 710 may be zoomable. A number of variations in the format, appearance, and/or content of such an exemplary interface 700 are contemplated and are considered to be within the scope of the present disclosure.

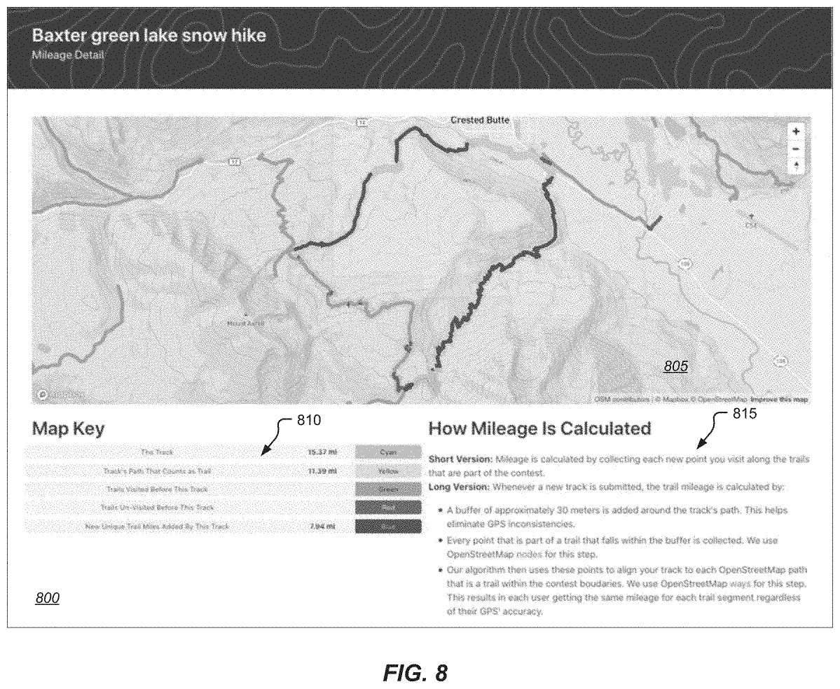

FIG. 8 is a screenshot illustrating an exemplary user interface presenting a track mileage explanation according to one embodiment of the present disclosure. More specifically, this example illustrates a web page or other interface 800 that can be generated by the miles algorithm 330 and/or map generator 340 and which may be presented, for example, in response to a user touching, clicking, or otherwise selected a “Help” or other button, icon, link, etc., or otherwise making a request for such information. As illustrated in this example, the interface 800 can include a zoomable map 805 illustrating a geographic region and a number of routes and/or route segments within that area. Again, these routes and/or route segments may be color-coded or otherwise distinguished to show portions completed, portions not yet, completed, etc. The interface 800 can also include a map key 810 explaining and/or illustrating the color-coding or other indications or distinctions between the route portions shown. Additionally, or alternatively, the interface 800 can include an explanation 815 of how mileage is calculated. A number of variations in the format, appearance, and/or content of such an exemplary interface 800 are contemplated and are considered to be within the scope of the present disclosure.

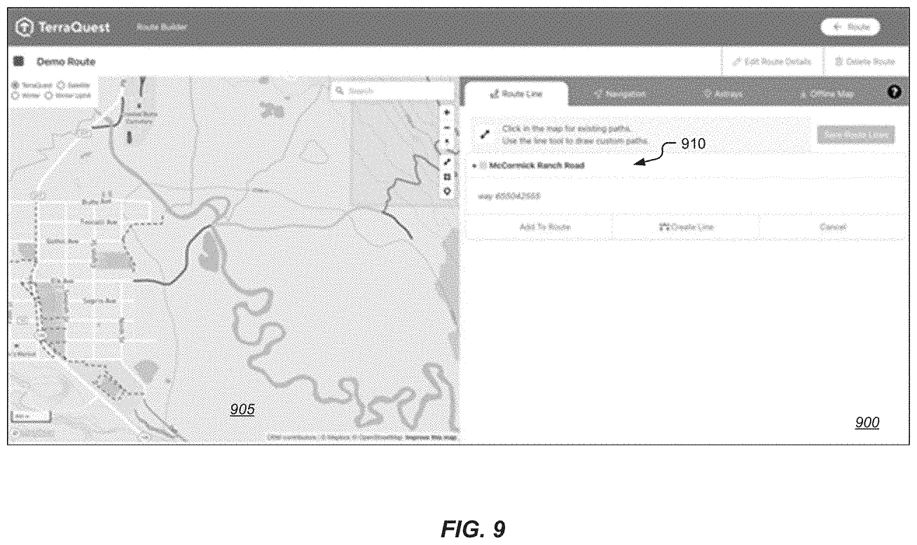

FIG. 9 is a screenshot illustrating an exemplary route builder user interface for adding geometries to a route according to one embodiment of the present disclosure. More specifically, this example illustrates a web page or other interface 900 that can be generated by the route generator 335 and which can include a map 905 of a geographic area including one or more trails and one or more routes and/or route segments on one or more of the trails. Also presented can be one or more controls 910 for adding a geometry to a route or route segment, e.g., adding a waypoint. A number of variations in the format, appearance, and/or content of such an exemplary interface 900 are contemplated and are considered to be within the scope of the present disclosure.

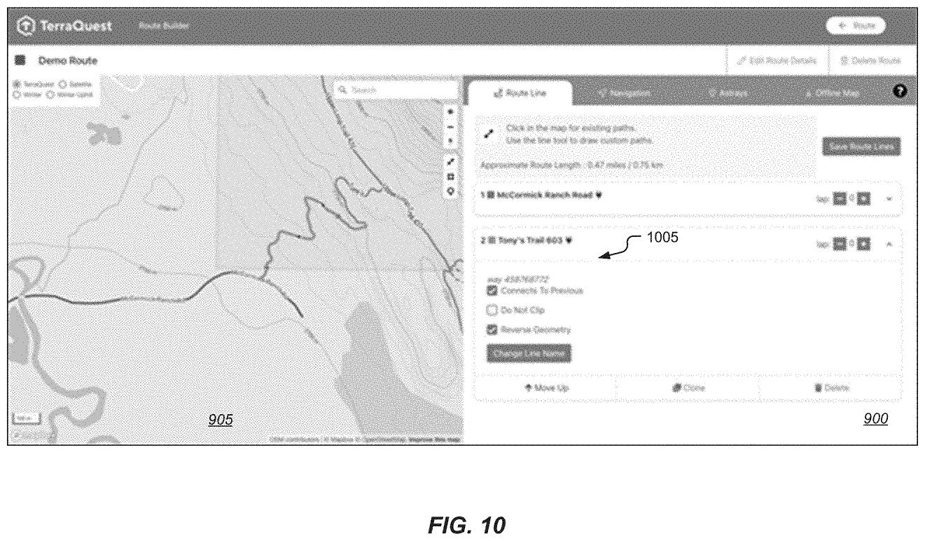

FIG. 10 is a screenshot illustrating an exemplary route builder user interface for adding geometry options to a route according to one embodiment of the present disclosure. More specifically, this example illustrates the web page 900 generated by the route generator 335 and including the map 905 as described above. Also presented in this example can be additional controls 1005 for defining one or more options for the added geometry (waypoint) such as whether it connects to a previous waypoint on a route or route segment, etc. A number of variations in the format, appearance, and/or content of such an exemplary interface 1000 are contemplated and are considered to be within the scope of the present disclosure.

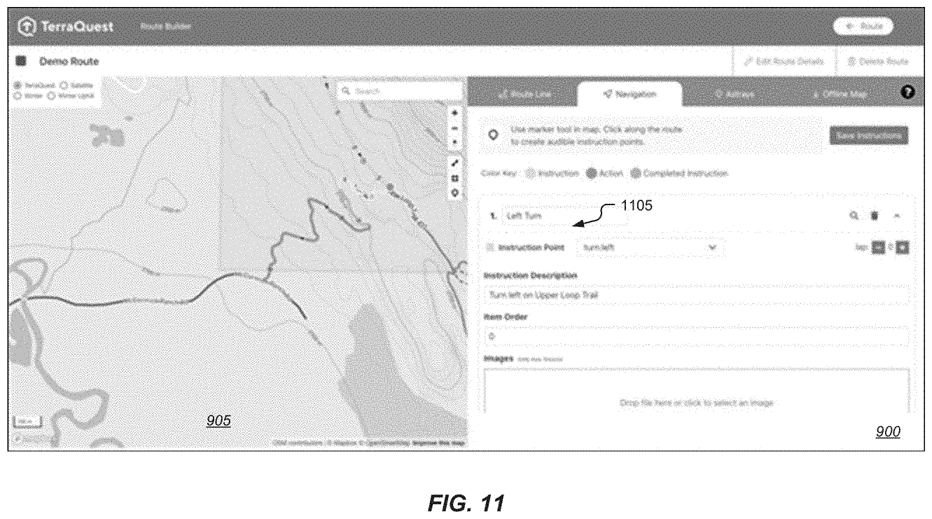

FIG. 11 is a screenshot illustrating an exemplary route builder user interface for adding route instructions to a route according to one embodiment of the present disclosure. More specifically, this example illustrates the web page 900 generated by the route generator 335 and including the map 905 as described above. Also presented in this example can be additional controls 1105 for defining one or more route instructions such as identifying or indicating an entry point, giving a turn instruction, etc. which can be presented to users navigating the route or route segment. A number of variations in the format, appearance, and/or content of such an exemplary interface 1100 are contemplated and are considered to be within the scope of the present disclosure.

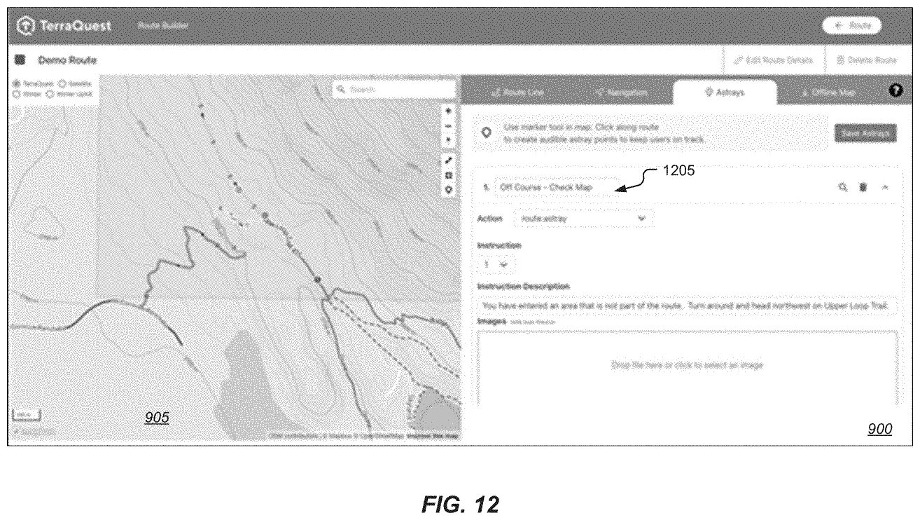

FIG. 12 is a screenshot illustrating an exemplary route builder user interface for adding a route astray to a route according to one embodiment of the present disclosure. More specifically, this example illustrates the web page 900 generated by the route generator 335 and including the map 905 as described above. Also included in this example can be a set of controls 1205 for creating and/or defining an astray, i.e., a point and set of associated instructions to be given to a user who reaches that point, e.g., to tell them they have gone off course and/or how to correct course to return to the route or route segment. A number of variations in the format, appearance, and/or content of such an exemplary interface 1200 are contemplated and are considered to be within the scope of the present disclosure.

According to one embodiment, the map generator 340 can filter the trails and/or routes presented based on a number of criteria. For example, different map styles can be present trails according to permitted activities. The different map styles can be presented based on OpenStreetMap (OSM) data by filtering possible OSM tags that could correctly generate the intended permitted activities.

An exemplary summer trail map filter can comprise, for example: --keep=“highway=path or highway=footway or highway=cycleway or highway=bridleway or highway=track”--keep-tags=“all name=highway=footway=foot=bicycle=horse=surface=cycleway=atv=motorcycle=smoothness=access=ohv=motor_vehicle=4wd_only=note=system_trail=. FIG. 13 is a screenshot illustrating an exemplary user interface including a map legend according to one embodiment of the present disclosure. More specifically, this example illustrates a mobile or other interface 1300 as may be generated by the map generator 340 and which can include a legend 1305 identifying and describing different trail types and/or permitted uses by color, lines dashes and/or weights, etc. A number of variations in the format, appearance, and/or content of such an exemplary interface 1300 are contemplated and are considered to be within the scope of the present disclosure.

In another example, a piste map filter can be comprise, for example: --keep=“piste:type=aerialway=building=highway=pylon”--keep-nodes=“amenity=”--keep-tags=“all piste:type=piste:name=name=piste:difficulty=piste:grooming=piste:dogs_allowed=aerialway=area=highway=pylon amenity=building=healthcare=fee=bicycle=hiking=. FIG. 14 is a screenshot illustrating an exemplary user interface including a piste map legend according to one embodiment of the present disclosure. More specifically, this example illustrates a mobile or other interface 1400 as may be generated by the map generator 340 and which can include a legend 1405 identifying and describing different trail types and/or permitted uses by color, lines dashes and/or weights, etc. A number of variations in the format, appearance, and/or content of such an exemplary interface 1400 are contemplated and are considered to be within the scope of the present disclosure.

FIG. 15 is a screen shot of a rendered map according to one embodiment of the present disclosure. More specifically, this example illustrates a representation of a map as rendered on a browser interface 1505 and on a smart watch interface 1510. As can be seen, do to the size differences between devices on which the map may be rendered, the smart watch interface 1510 represents a portion 1515 of the map rendered on the browser interface 1505. A number of variations in the format, appearance, and/or content of such an exemplary browser interface 1505 and/or smart watch interface 1510 are contemplated and are considered to be within the scope of the present disclosure.

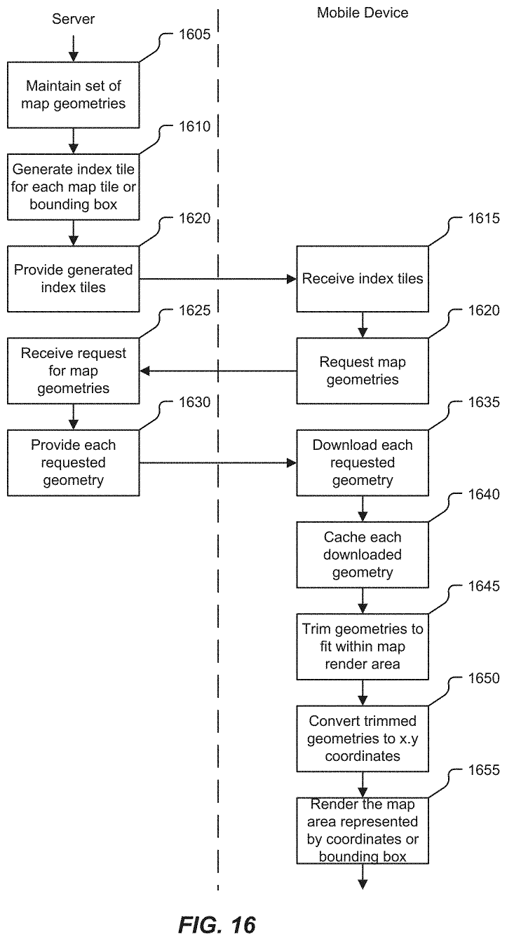

FIG. 16 is a flowchart illustrating an exemplary process for vector map rendering according to one embodiment of the present disclosure. According to one embodiment and as illustrated in this example, generating an index tile-based vector map of a geographic area can comprise maintaining 1605, by a server 305, a plurality of map geometries 360 representing the geographic area. Each geometry of the plurality of geometries can have a geometry type of a plurality of geometry types, and each geometry of the plurality of geometries can characterize a geographic feature represented in the geographic area. An index tile 365 can be generated 1610 by the server 305 for each of the plurality of map geometries 360. The index tile 365 can comprise a list of each geometry type in the map or bounding box and a list of identifiers for each geometry type, the list of identifiers can indicate the geometries of the plurality of geometries for each geometry type. The generated index tiles 365 for the plurality of map tiles can be provided 1620 by the server 305 to a mobile device 315A and the mobile device 315A can use one or more of the index tiles 365 to download the plurality of geometries of one or more map geometries 360.

That is, the mobile device 315A can receive 1615, from the server 305, the index tile 365 for each map tile or bounding box for the geographic area. The mobile device 315A can then request 1620, from the server 305, one or more geometries of at least one map tile or bounding box for a map render area based on at least one of the index tiles 365. In some cases, requesting 1620 the one or more geometries of the at least one map tile or bounding box can comprise requesting to download an individual geometry identified in one of the generated index tiles 365 provided to the mobile device 315A. In other cases, requesting 1620 the one or more geometries of the at least one map tile or bounding box can comprise providing, by the mobile device 315A, to the server 305, one of the index tiles 365 received 1615 by the mobile device 315A and in reply the mobile device 315A can receive, from the server 305, all of the geometries identified in the provided index tile 365. In some cases, each index tile 365 can comprise a JSON document.

The request to download one or more geometries of at least one of the map geometries 360 can be received 1625 by the server 305 from the mobile device 315A. In response to the request to download the one or more geometries of the at least one map tile or bounding box, the server 305 can provide 1630 to the mobile device 315A the requested one or more geometries. In response to requesting the one or more geometries of the at least one map tile or bounding box, the mobile device 315A can download 1635, from the server 305, the requested one or more geometries. Downloading 1635 the one or more geometries of the at least one map tile or bounding box can comprise providing, to the server, by the mobile device 315 and as part of requesting 1620 the map geometries, a JSON document requesting only specific geometries of one or more index tiles 365. In such cases, the JSON document can comprise one or more keys, each key comprising a geometry type, and a value comprising either a Boolean value or a tag name for one or more geometries.

The mobile device 315A can, in some cases, cache 1640 the downloaded one or more geometries. The downloaded and/or cached one or more geometries can be trimmed 1645 by the mobile device 315A to fit within boundaries for the at least one map tile or bounding box and the trimmed one or more geometries can be converted 1650 to screen x, y coordinates. The map area represented by the x, y coordinates or the bounding box can then be rendered 1655 by the mobile device using the screen x, y coordinates.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for generating an index tile-based vector map of a geographic area, the method comprising:
maintaining, by a server, a plurality of map geometries representing the geographic area, each geometry of the plurality of geometries having a geometry type of a plurality of geometry types, and each geometry of the plurality of geometries characterizing a geographic feature in the geographic area;
generating, by the server, an index tile for each map tile or bounding box for a map render area, wherein the index tile comprises a list of each geometry type in the map tile or bounding box and a list of identifiers for each geometry type, the list of identifiers indicating the geometries of the plurality of geometries for each geometry type; and
providing, by the server, to a mobile device, the generated index tiles for the plurality of map geometries, wherein the mobile device uses one or more of the index tiles to download the plurality of geometries of one or more map tiles or bounding boxes.

2. The method of claim 1, further comprising:
receiving, by the server, from the mobile device, a request to download one or more geometries of at least one map tile or bounding box for a map render area; and
in response to the request to download the one or more geometries of the at least one map tile or bounding box, providing, by the server, to the mobile device, the requested one or more geometries.

3. The method of claim 2, wherein the request to download the one or more geometries of the at least one map tile or bounding box comprises a request to download an individual geometry identified in one of the generated index tiles provided to the mobile device.

4. The method of claim 2, wherein the request to download the one or more geometries of the at least one map tile or bounding box comprises one of the generated index tiles provided to the mobile device and wherein providing the requested one or more geometries comprise providing, by the server, to the mobile device, all of the geometries identified in the index tile provided with the request.

5. The method of claim 2, wherein each index tile comprises a JavaScript Object Notation (JSON) document.

6. The method of claim 5, wherein the request to download the one or more geometries of the at least one map tile or bounding box comprises a JSON document requesting only specific geometries of one or more index tiles, the JSON document comprising one or more keys, each key comprising a geometry type, and a value comprising either a Boolean value or a tag name for one or more geometries.

7. A method for rendering an index tile-based vector map of a geographic area, the method comprising:
receiving, by a mobile device, from a server, an index tile for each map tile of a plurality of map geometries for the geographic area, each map tile comprising a plurality of geometries, each geometry of the plurality of geometries having a geometry type of a plurality of geometry types, and each geometry of the plurality of geometries characterizing a geographic feature represented in the map tile, wherein the index tile comprises a list of each geometry type in the map tile and a list of identifiers for each geometry type, the list of identifiers indicating the geometries of the plurality of geometries for each geometry type;
requesting, by the mobile device, from the server, one or more geometries of at least one map tile or bounding box for a map render area based on at least one of the index tiles; and
in response to requesting the one or more geometries of the at least one map tile or bounding box downloading, by the mobile device, from the server, the requested one or more geometries.

8. The method of claim 7, further comprising caching, by the mobile device, the downloaded one or more geometries.

9. The method of claim 7, further comprising:
trimming, by the mobile device, the downloaded one or more geometries to fit within boundaries for the at least one map tile or bounding box;
converting, by the mobile device, the trimmed one or more geometries to screen x, y coordinates; and
rendering, by the mobile device, the map area represented by the x, y coordinates or the bounding box.

10. The method of claim 7, wherein requesting the one or more geometries of the at least one map tile or bounding box comprises requesting to download an individual geometry identified in one of the generated index tiles provided to the mobile device.

11. The method of claim 7, wherein requesting the one or more geometries of the at least one map tile or bounding box comprises providing, by the mobile device, to the server, one of the index tiles received by the mobile device and wherein downloading the requested one or more geometries comprise downloading, by the mobile device, from the server, all of the geometries identified in the provided index tile.

12. The method of claim 7, wherein each index tile comprises a JavaScript Object Notation (JSON) document.

13. The method of claim 12, wherein requesting the one or more geometries of the at least one map tile or bounding box comprises providing, by the mobile device, to the server, a JSON document requesting only specific geometries of one or more index tiles, the JSON document comprising one or more keys, each key comprising a geometry type, and a value comprising either a Boolean value or a tag name for one or more geometries.

14. A system comprising:
a server comprising a processor and a memory coupled with and readable by the processor and storing therein a set of instructions which, when executed by the processor of the web server, causes the processor of the web server to generate an index tile-based vector map of a geographic area by:
maintain a plurality of map geometries representing the geographic area, each geometry of the plurality of geometries having a geometry type of a plurality of geometry types, and each geometry of the plurality of geometries characterizing a geographic feature represented in the geographic area,
generate an index tile for each map tile or bounding box for a map render area, wherein the index tile comprises a list of each geometry type in the map tile and a list of identifiers for each geometry type, the list of identifiers indicating the geometries of the plurality of geometries for each geometry type, and
provide the generated index tiles for the plurality of map geometries, wherein the mobile device uses one or more of the index tiles to download the plurality of geometries of one or more map tiles; and
a mobile device communicatively coupled with the server, the mobile device comprising a display device, a processor coupled with the display device, and a memory coupled with and readable by the processor of the mobile device and storing therein a set of instructions which, when executed by the processor of the mobile device, causes the processor of the mobile device to render the index tile-based vector map by:
receiving, from the server, the provided index tiles for the plurality of map, and
requesting, from the server, one or more geometries of at least one map tile or bounding box for a map render area based on at least one of the index tiles.

15. The system of claim 14, wherein the instructions stored in the memory of the server, further cause the processor of the server to receive, from the mobile device, the request for the one or more geometries of at least one map tile or bounding box and in response to the request, provide, to the mobile device, the requested one or more geometries, and wherein the instructions stored in the memory of the mobile device, further cause the processor of the mobile device to download, from the server, the requested one or more geometries.

16. The system of claim 15, wherein the instructions stored in the memory of the mobile device further cause the processor of the mobile device to cache the downloaded one or more geometries.

17. The system of claim 15, wherein the instructions stored in the memory of the mobile device further cause the processor of the mobile device to:
trim the downloaded one or more geometries to fit within boundaries for the at least one map tile or bounding box;
convert the trimmed one or more geometries to screen x, y coordinates; and
render, on the display device, the at least one map tile or bounding box using the screen x, y coordinates.

18. The system of claim 14, wherein requesting the one or more geometries of the at least one map tile or bounding box comprises requesting to download an individual geometry identified in one of the generated index tiles provided to the mobile device.

19. The system of claim 14, wherein requesting the one or more geometries of the at least one map tile or bounding box comprises providing, by the mobile device, to the server, one of the index tiles received by the mobile device and wherein downloading the requested one or more geometries comprise downloading, by the mobile device, from the server, all of the geometries identified in the provided index tile.

20. The system of claim 14, wherein each index tile comprises a JavaScript Object Notation (JSON) document and wherein requesting the one or more geometries of the at least one map tile or bounding box comprises providing, by the mobile device, to the server, a JSON document requesting only specific geometries of one or more index tiles, the JSON document comprising one or more keys, each key comprising a geometry type, and a value comprising either a Boolean value or a tag name for one or more geometries.
